(19) United States
(12) Patent Application Publication
(10) Pub. No.: US 2023/0035372 A1
(43) Pub. Date: Feb. 2, 2023

(54) TRI-REGIME COMPOSITE SOLID PROPELLANT

(71) Applicants: David Reid, Cocoa, FL (US); Michael Fisher, Springboro, OH (US); Catherine Anne Marie Dillier, Belcamp, MD (US); Andrew Robert Demko, Ridgecrest, CA (US); Eric L. Petersen, College Station, TX (US)

(72) Inventors: David Reid, Cocoa, FL (US); Michael Fisher, Springboro, OH (US); Catherine Anne Marie Dillier, Belcamp, MD (US); Andrew Robert Demko, Ridgecrest, CA (US); Eric L. Petersen, College Station, TX (US)

(21) Appl. No.: 17/740,520

(22) Filed: May 10, 2022

Related U.S. Application Data
(60) Provisional application No. 63/186,330, filed on May 10, 2021.

(51) Int. Cl. F02K 9/12; C06B 33/02; C06B 45/10; C06B 45/08

(52) U.S. Cl. CPC F02K 9/12; C06B 33/02; C06B 45/10; C06B 45/08

(57) ABSTRACT

The present invention is a composite solid propellant designed to operate in three distinct combustion regimes under various pressure states in the combustion chamber of a solid rocket motor. The design of this propellant facilitates desirable rocket motor operational characteristics, including throttleability, extinguishment, and self-destruction or detonability. The propellant contains ingredients that modify the propellant combustion characteristics to provide the desired behavior, including a surfactant and unaggregated, unagglomerated dispersed primary nanoparticles of aluminum in a polymer binder.

### CROSS REFERENCE TO RELATED APPLICATIONS

This application claims the benefit of U.S. Provisional Application No. 63/186,330 filed on May 10, 2021. The entire contents of these applications are incorporated herein by reference in their entirety.

### STATEMENT REGARDING FEDERALLY FUNDED RESEARCH

The subject invention was made with U.S. Government support under Contract No. FA8651-18-P-0007 with the Air Force Research Laboratory (AFRL) and No. N68335-16-C-0032 with the U.S. Navy. The U.S. Government has certain rights in this invention.

### FIELD OF THE INVENTION

The present invention relates to a solid rocket propellant designed to operate in three distinct combustion regimes under various pressure states in the combustion chamber of a solid rocket motor. The design of this propellant facilitates desirable rocket motor operational characteristics, including throttleability, extinguishment, and self-destruction or detonability.

### BACKGROUND OF THE INVENTION

A solid rocket motor or composite propellant rocket motor is a propulsion system with a motor that uses solid propellants comprising a fuel, an oxidizer and a polymer binder material. The solid propellant is normally in the form of a propellant grain located within the interior of the rocket motor pressure vessel, or combustion chamber, and burned to produce hot gases which, in turn, exit through the throat and expansion nozzle of the rocket motor at high velocity to provide thrust which propels the rocket in the opposite direction.

Although liquid rockets are commonly used today in large rocket systems due to better efficiency and controllability as compared to solid rockets, solid rockets are still used in certain applications including military tactical missile systems primarily because they are relatively easy to manufacture and generally exhibit excellent performance characteristics. In addition, solid rockets are generally less complex as compared to those employing liquid fuels, and are more easily transported and safely stored for long periods of time while waiting to be used. However, unlike liquid propellant rockets, solid propellant rockets are generally unable to control or alter their thrust characteristics after ignition by adjusting the amount of fuel entering the area of combustion.

Challenging new military missions are requiring these tactical missile systems to generate greater lethality from volume-limited missile platforms while also providing more flexible performance to accommodate variable mission parameters. These new challenges require the development of new materials and engineering design approaches. Potential solutions to these needs include energetic materials such as propellants that can be adapted for use in both propulsion and lethality roles, providing dynamic allocation of energy from a single energetic charge, thereby eliminating the need for separate solid rocket motor propellant and warhead explosive. Such energetic materials would achieve efficient use of available volume while, at the same time, providing crucial performance flexibility and the required lethality. Control of the energetic material's combustion behavior is essential to achieving the required performance flexibility since regulation of the amount of fuel in the combustion chamber is not possible with solid propellants.

The key performance parameter of a rocket propulsion system is the amount of thrust generated by the exiting hot gases. The magnitude of thrust is related to the burning rate of the solid propellant, which is sensitive to the operating pressure of the motor combustion chamber. As the operating pressure increases, so does the propellant burning rate under normal conditions. This sensitivity of the burning rate to pressure (expressed by the pressure exponent) can be used as a means of controlling, or throttling, the performance of the rocket motor, as the throat, or region of smallest diameter, of the nozzle is adjusted in size to adjust the pressure. For this method of throttling to work effectively, propellants should have relatively high (close to 1) pressure exponents to provide the needed response. However, conventional propellants with exponents approaching unity (1) present an instability problem due to the risk of runaway pressure increase in the motor.

One approach to protect the motor from runaway pressure is to design a propellant that exhibits a region of near-zero (or negative) burning rate exponent, also called a plateau region, over a wide pressure range. The plateau region should begin at a higher pressure than the high-exponent region, but still below the maximum design operating pressure of the motor. In order to enhance the energetic material's contribution to lethality at target intercept, the burning rate exponent must also transition back to a high value beyond this plateau region, allowing for runaway pressure to cause an explosive destruction of the motor. This capability could also be used for self-destruction purposes, in order to eliminate the need for a separate explosive device.

Although “plateau” solid propellants have been previously demonstrated, the Present Inventors are not aware of an existing propellant exhibiting the combination of combustion behavior described above for a throttleable, extinguishable, plateau enabled, tri-regime energetic material.

An example prior art plateau-burning propellant is known from U.S. Pat. No. 5,334,270, Taylor (1994) (“Taylor 1994”) and US 005771679A, Taylor and Hinshaw (1998) (“Taylor 1998”). In these patents, Taylor discloses composite solid propellants which feature burning rate plateaus (near zero slope in the burning rate versus pressure relationship) over various pressure ranges. Taylor does not disclose propellants that exhibit high (near 1.0) slopes in the low-pressure region, and does not disclose propellants that could facilitate throttling and/or extinguishment of a rocket motor via commanded changes in rocket motor chamber pressure.

Taylor 1998 and Taylor 1994 state that a refractory metal oxide is needed, at a content of 0.3-5.0 wt %, to produce the plateau burning effect. Since this refractory metal oxide occupies volume in the propellant that could otherwise be occupied by a fuel or oxidizer, the result of including the refractory metal oxide is a reduction in density-specific impulse, a measure of the energy content of the propellant. This effect negatively impacts the operational performance of a propulsion system using this propellant. Taylor's propellant suffers from the disadvantage that it also requires a combination of both coarse and fine particle sizes of ammonium perchlorate (“AP”) to achieve plateau burning, including ultrafine AP in the particle size range of 1-5 micrometers. This ultrafine AP presents safety and propellant processing difficulties due to its high specific surface area. A propellant with equivalent or better burning rate characteristics that does not require the use of ultrafine AP would be advantageous over Taylor's propellant.

In U.S. Pat. No. 8,114,229 B1 “Self-Extinguishable Solid Propellant”, Petersen et al. describe the use of surfactants such as sodium dioctyl sulfosuccinate (AOT) in propellants to produce a negative slope in the burning rate versus pressure behavior, which ultimately causes the propellant to cease burning above a certain pressure threshold. Petersen describes this behavior as an “apex” burning rate profile. The use of surfactants presents a different method to that of Taylor for modifying the burning rate slope of propellant; however, as a result, the “apex” burning rate profile and high-pressure self-extinguishing characteristic may not be desirable for many applications.

Available technology to accomplish the above-described usage case of throttling, extinguishing, and then re-igniting or detonating a solid rocket motor would require multiple energetic material formulations with different combustion properties, as well as complex mechanical systems and motor hardware features to accomplish rapid depressurization of the motor and re-ignition of propellants. Therefore, a propellant which overcomes the key prior art limitations and the above-described problems associated with prior art composite solid propellants enabling multi-regime burning rates, including those intended for dual use as both a propellant and an explosive (i.e. provide both propulsive and lethality roles in a missile system), is desired.

Propellants with plateau and/or tri-regime burning rate characteristics would be useful for a variety of applications beyond the above-described usage cases. For example, a plateau burning composite propellant could be used in place of the plateau-burning double base propellants used in certain propellant-actuated devices (PAD). In PAD applications, a composite propellant would be advantageous over a double base propellant due to the longer service life and better thermal stability of composite propellants over double base propellants. Plateau burning propellants are also useful in certain rocket motor applications in which low sensitivity to changes in combustion chamber pressure is desired.

### BRIEF SUMMARY OF THE INVENTION

The present invention is a composite solid propellant that includes an oxidizing agent, a polymer binder system, and a surfactant additive. The polymer binder system includes unoxidized metal nanoparticles dispersed as primary nanoparticles, without forming agglomerates, within the polymer.

The propellant may optionally contain other types of metal particles, and additives that are known to those familiar with the art, including but not limited to bonding agents, metal-oxides, cure catalysts, and plasticizers. The propellant composition facilitates operation in three distinct combustion regimes under various pressure states in the combustion chamber of a solid rocket motor. The three distinct regions are (1) a low-pressure region in which the propellant as a high burning rate slope, (2) a mid-pressure region in which the propellant has a low, zero, or negative burning rate slope, and (3) a high-pressure region in which the propellant has a high burning rate slope.

### BRIEF DESCRIPTION OF THE DRAWINGS

The present disclosure will be better understood by reading the written description with reference to the accompanying drawing Figures in which:

FIG. 1 graphically shows a burning rate behavior of an AP/HTPB composite solid propellant formulated in accordance with the prior art;

FIG. 2 graphically presents burning rate data for a tri-regime composite solid propellant constructed in accordance with the present invention; and

FIG. 3 graphically presents burning rate data for a tri-regime composite solid propellant constructed in accordance with a second embodiment of the present invention.

### DETAILED DESCRIPTION OF THE PREFERRED EMBODIMENTS

Disclosed embodiments in this Disclosure are described with reference to the attached figures, which are provided merely to illustrate the disclosed embodiments. Several aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring structures or operations that are not well-known. This Disclosure is not limited by the illustrated ordering of acts or events, as some acts may occur in different orders and/or concurrently with other acts or events. Furthermore, not all illustrated acts or events are required to implement a methodology in accordance with this Disclosure.

Notwithstanding that the numerical ranges and parameters setting forth the broad scope of this Disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

Embodiments of the invention describe new tri-regime composite propellant compositions. Generally, the propellant compositions contain aluminum nanoparticles (with little or no aluminum-oxide content), which are dispersed as unaggregated, unagglomerated primary nanoparticles within the polymer binder, and one or more types of surfactant also dissolved in the polymer binder. The surfactants and aluminum nanoparticles modify the propellant combustion characteristics to produce a plateau burning rate effect, which includes regions of low, zero, or negative burning rate slope. These propellants also feature high burning rate slopes (close to 1) in the low-pressure region, which enables throttleability and/or extinguishment in response to changes in the rocket motor chamber pressure. The composition of these propellants (eliminating the need for refractory metal-oxides) and the performance characteristics (“tri-regime behavior”) overcome the key prior art limitations and the above described problems associated with prior art composite solid propellants.

As described above, a tri-regime composite propellant refers to a solid rocket propellant designed to operate in three distinct combustion regimes under various pressure states in the combustion chamber of a solid rocket motor. These three distinct combustion regimes include an initial regime that provides a burning rate as a function of pressure defined by a highly positive pressure dependence in the lower range of operating pressure, followed by a neutral (“plateau”) burning regime spanning a wide pressure range wherein burning rate dependence on pressure is zero or negative, and a third combustion regime at high operating pressure in which the propellant returns to a highly positive burning rate dependence on pressure. A tri-regime composite propellant allows a rocket motor made from a uniform propellant grain (i.e. a propellant grain consisting of a single formulation) to behave in different ways (i.e. have different burning rate slopes) depending on the chamber pressure.

Disclosed embodiments include composite solid propellants comprising unoxidized, unagglomerated nanoparticles of aluminum dispersed in a polymer binder material, a solid oxidizing agent, and one or more type of surfactant dissolved in the polymer binder. The propellants may additionally contain other types of metal particles including aluminum powder, boron, and magnesium, various curatives including diisocyanates, various plasticizers, bonding agents, catalysts, antioxidants, and other ingredients known to the propellant trade. Energetic ingredients including explosives such as RDX, HMX, and CL-20, may be included as partial substitutions for the oxidizer in order to increase the detonability of the propellant. Many ingredients may optionally be included in the propellants, such as those known in the prior art to affect mechanical properties, aging characteristics, temperature response, and performance. It is understood that certain ingredients may be expected to interfere with, by either enhancing or diminishing, the high slope and plateau regions that are created by the combination of surfactant(s) and aluminum nanoparticles in the disclosed embodiments.

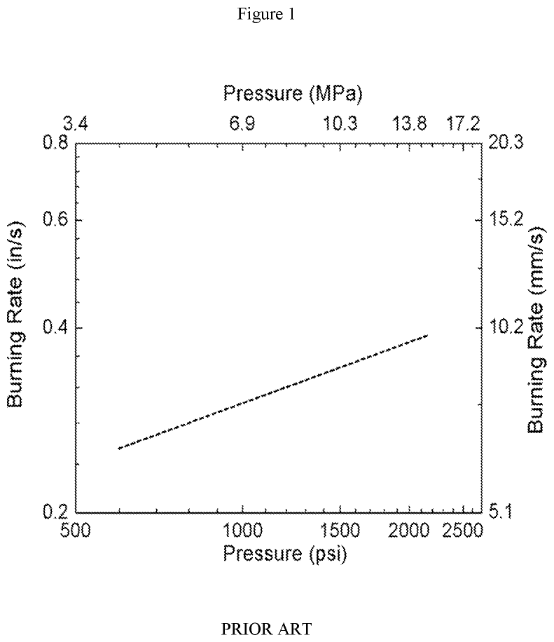

FIG. 1 shows burning rate data for a conventional 85 mass %/15 mass AP/HTPB (ammonium perchlorate/hydroxyl-terminated polybutadiene) solid propellant. This conventional AP/HTPB solid propellant is seen to increase in burning rate as the pressure increases in a generally linear fashion when plotted on log-log axes; i.e. the burning rate approximately follows a power law with pressure of the form r=apⁿ, in which r is the burning rate, p is the pressure, and a and n are constants called the pre-exponent and the exponent, respectively.

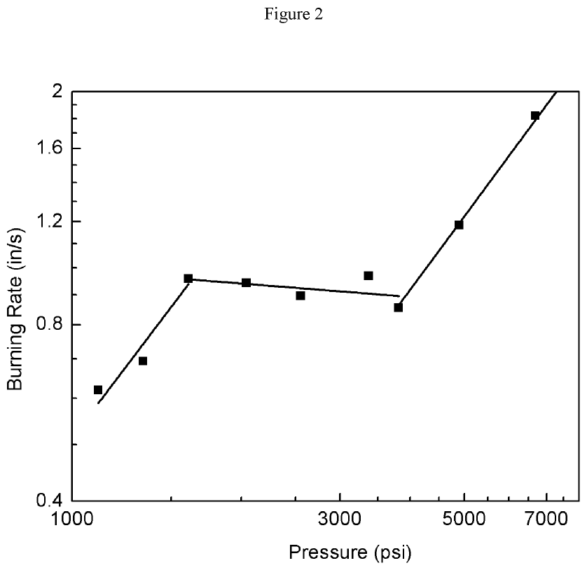

In contrast, in an embodiment of the invention, AP/HTPB solid propellant containing the surfactant additive and unaggregated, unagglomerated dispersion of primary nanoparticles of aluminum in the polymer binder exhibits the tri-regime burning rate profile previously described. Measured burning rates of an example tri-regime propellant are show in in FIG. 2, which exhibits the characteristic three regions: (1) a low-pressure region with a high slope, (2) a plateau region with a flat or negative slope, and (3) a high-pressure region with a high slope. Accordingly, it is the fundamental combustion characteristics of the above propellant formulation that creates this tri-regime effect, not some special design of the propellant grain. The burning rate of the propellant responds to changes in pressure.

The oxidizing agent can comprise a variety of oxidizing agents. In certain embodiments, the oxidizing agent comprises AP, ammonium nitrate (AN), or ammonium dinitramide (ADN).

The binder material can comprise a variety of binders. Many of the known binder materials are polymeric materials. In certain embodiments, the binder material comprises HTPB, hydroxy-terminated polyether (HTPE), hydroxy-terminated caprolactone ether (HTCE), glycidyl azide polymer (GAP).

The surfactant additive generally comprises 1 to 10 wt % of the composite propellant. The surfactant can generally be a non-ionic, anionic, cationic or zwitterionic surfactant. In one embodiment of the invention, the surfactant comprises an anionic surfactant, such as sodium dioctyl sulfosuccinate (AOT). In another embodiment, the surfactant comprises a non-ionic surfactant such as polyoxyethylene (10) cetyl ether, sold under the trade name “Brij C10”. In another embodiment, the surfactant comprises a mixture of surfactant types, for example a mixture of AOT and Brij C10.

Due to the strongly exothermic aluminum (Al) to aluminum oxide (Al₂O₃) reaction, powdered aluminum has long found use in energetic materials including solid propellants. The rate of reaction is proportional to the surface area available for oxidation, and thus there is significant interest in the use of nanoscale Al powders in energetic materials. Commercial ultrafine Al powders are typically produced by electro-explosion of aluminum wire, or by plasma synthesis methods. However, the commercially available powders are of 100-200-nm particle diameter, well above the nano regime at which dramatic increases in surface area and reactivity are expected. In fact, some studies on truly nanoscale Al powders found that they perform more poorly than expected because a native aluminum oxide layer forms on the surface of metallic Al upon exposure to air. In the case of nanoscale Al powders, the aluminum oxide layer encompasses a large fraction of the overall particle mass, leaving little remaining reactive aluminum in Al nanopowders formed by conventional methods.

To overcome this problem, a solution-based chemical method was used by the Present Inventors to synthesize Al nanoparticles for use in the disclosed invention. U.S. Pat. No. 9,573,857 B2, Reid et al. (2017) (“Reid”) describes a method to synthesize nanoparticles of aluminum beginning with a molecular precursor of aluminum such as an amine adduct of alane, and combining it with a polymer such as hydroxyl terminated polybutadiene (HTPB), to which has been bonded an organometallic complex that acts as a catalyst to decompose the aluminum precursor. Upon combining the aluminum precursor with the catalyst-functionalized polymer, the precursor decomposes to form metallic aluminum particle nuclei, which as they form become coated with the catalyst-attached polymer molecules. This reaction mechanism, involving the simultaneous formation of aluminum particle nuclei by action of the catalyst and their coating with the polymer to which the catalyst is attached, produces a composite material containing primary nanoparticles of aluminum dispersed in a polymer, which can be used as a binder component in a propellant or explosive, in which the rapid combustion of the dispersed primary aluminum nanoparticles increases the propellant or explosive performance.

This method, known as in situ processing of polymer nanocomposites, allows production of very small (e.g. 5-30 nm average size) aluminum nanoparticles with little or no aluminum-oxide content. This synthesis method has the advantage of greater control of particle size and morphology, allows the use of a variety of passivating materials, and does not require any special equipment (only an oxygen-free reaction environment).

The unoxidized, unagglomerated primary aluminum nanoparticles can comprise 0.01-15 wt % of the solid composite propellant. The aluminum nanoparticles are produced within the polymer binder using the synthesis method described above.

One embodiment of the disclosed invention is a composite solid propellant incorporating ammonium perchlorate (AP) oxidizer that has a tailored particle size distribution, in situ synthesized aluminum nanoparticles, and a surfactant-type additive, to produce a tri-regime propellant as described above. This embodiment comprises an HTPB binder loaded with less than 5 wt % aluminum nanoparticles formed using the previously described in situ synthesis method; AOT and Brij C10 as the surfactant additives; and AP sieved to achieve a specific particle distribution. In one embodiment, the AP is passed through two sieves: a 90-micrometer sieve and a 25-micrometer sieve, and the portion retained on the 25-micrometer sieve (i.e. containing particles predominantly between 90 micrometers and 25 micrometers in size) is used. Other solid fuels, such as micrometric (greater than 100 nm diameter) aluminum powder or boron powder, may be added. The propellant mixture is cured using a diisocyanate curative such as isophorone diisocyanate (IPDI).

The particle size distribution and concentration of the oxidizer is understood to influence the characteristics of the three combustion regimes. The pressure ranges encompassing the low/plateau/high slope regions, as well as the burning rate slopes within those regions, can be tailored by customizing the oxidizer particle size distribution and concentration. For example, fine, ultrafine, or coarse particle grades of oxidizer can be used alone or in combination to produce monomodal, bimodal, or trimodal particle size distributions to tailor the burning rate regimes to meet the requirements of a given rocket motor application. Likewise, the concentrations of the surfactant and aluminum nanoparticle ingredients described in the present invention may be customized to tailor the burning rate profile for specific application needs.

A mixture of oxidizers and energetic ingredients may be used to achieve the desired performance or sensitivity to detonation. For example, a mixture of AP and an energetic ingredient such as RDX or HMX may be included to modify the propellant performance and make it more susceptible to detonation.

An example composition of a tri-regime propellant is given in Table 1.

TABLE 1

| Ingredient | Mass % |
|---|---|
| HTPB | 17.38 |
| Tepanol | 0.1 |
| AOT | 3.6 |
| Brij C10 | 0.4 |
| AP | 76.7 |
| IPDI | 1.7 |
| nAl | 0.12 |

Propellant compositions (i.e. ingredient concentrations) may be varied in order to achieve the wide range of physical, mechanical, and combustion characteristics that are typical for composite solid propellants. For example, factors such as the total mass loading of solid ingredients, the fuel:oxidizer ratio, and the total metal content can be adjusted to meet the requirements of different types of rocket motors, such as density requirements, specific impulse requirements, or smoke signature requirements.

Typical ingredient concentration ranges are listed as the following in mass percentage. Total aluminum (i.e. the total of aluminum nanoparticles and larger aluminum particles): 0.01%-30%; oxidizer: 50%-90%; energetic ingredients (e.g. HMX, RDX): 0%-50%; surfactants: 1%-10%.

The tri-regime propellants according to embodiments of the present invention can be generally prepared using conventional mixing equipment and techniques, according to the following sequential steps:

1. Binder containing in-situ synthesized Al is used directly as the propellant binder
2. The surfactant is dissolved into the liquid binder
3. Bonding agent and plasticizer, if included, are added
4. Binder mixture is then placed under vacuum to remove air bubbles
5. Solid fuels, such as metal powders, if used, are incrementally added
6. Solid oxidizer is added
7. The diisocyanate curative is added, followed by mixing and an additional vacuum step to remove entrained air.
8. The mixture is then cast or otherwise formed into the desired shape of the propellant, and allowed to cure.

In experiments conducted by the present inventors, the exemplary tri-regime propellant described above, with the composition shown in Table 1, exhibited a burning rate slope of 0.6-1.0 between 500 and 2,000 psi, followed by a flat or slightly negative burning rate slope between 2,000-4,000 psi, and then a high burning rate slope of 1.0-2.5 above 4,000 psi. Burning rate data are shown in FIG. 2. This embodiment is designed to provide a unique combination of throttlability, stability (due to the broad burning rate plateau), and enhanced destructive potential due to the propellant's high sensitivity at high pressure (above 4,000 psi).

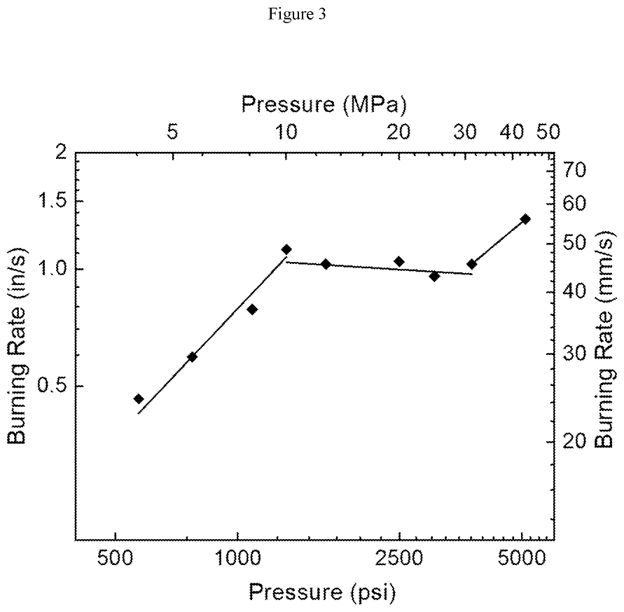

A second example of a tri-regime propellant composition is given in Table 2. This composition contains micrometric aluminum powder. The AP was passed through two sieves: a 75-micrometer sieve and a 25-micrometer sieve, and the portion retained on the 25-micrometer sieve (i.e. containing particles predominantly between 75 micrometers and 25 micrometers in size) was used. In experiments conducted by the present inventors, this second exemplary tri-regime propellant exhibited a burning rate slope of approximately 1.1 between 500 and 1,300 psi, followed by a slope of approximately −0.06 between 1,300 psi and 3,700 psi, and a slope of approximately 0.9 above 3,700 psi. The burning rate data are shown in FIG. 3.

TABLE 2

| | Mass |
|---|---|
| Ingredient | % |
| HTPB | 18.73 |
| Tepanol | 0.1 |
| AOT | 3.6 |
| Brij C10 | 0.4 |
| AP | 71.65 |
| IPDI | 1.79 |
| Al | 3.6 |
| nAl | 0.13 |

The inventors discovered that the propellants described in the disclosed embodiments provide the combination of distinct burning rate vs. pressure regimes required to meet the previously stated requirements for dual use in providing both propulsion and lethality using a single energetic material and a method for adjusting chamber pressure. Example methods for adjusting chamber pressure include the following: the use of a tapered plug, or pintle, which is axially translated in and out of the nozzle throat, causing the annular throat area to decrease or increase thrust capability; mechanical or explosive means of venting the rocket motor chamber to decrease chamber pressure; liquid or gas injection into the combustion chamber to vary chamber pressure. The disclosed embodiments of the present invention exhibit the following capabilities, which are improvements over prior art and currently available means for an energetic material to provide both propulsive (as a propellant) and lethality (to enhance damage, blast, fragment, or explosive) functionality:

1. Exhibit high burning rate slope over low operating pressure range, facilitating throttlability and/or the ability to extinguish propellant combustion by commanded changes in chamber pressure. Example methods for adjusting chamber pressure include the following: the use of a tapered plug, or pintle, which is axially translated in and out of the nozzle throat, causing the annular throat area to decrease or increase thrust capability; mechanical or explosive means of venting the rocket motor chamber to decrease chamber pressure; liquid or gas injection into the combustion chamber to vary chamber pressure.

2. Exhibit a broad plateau burning region, across a pressure range spanning around 1,000 psi or more, to provide a margin of safety during sustained rocket motor operation.

3. Exhibit a high burning rate slope at high pressure, providing a means of motor destruction by commanded over pressurization.

4. Achieve plateau burning without the necessary use of refractory metal oxides, which reduce propellant density-impulse.

5. Achieve plateau burning without the use of fine particles of AP, which pose safety and processing challenges.

The described tri-regime propellant has characteristics that are useful for other rocket motor applications outside the field of missile systems. For example, the propellant provides similar burning rate behavior to certain double-base propellants that exhibit burning rate plateaus or mesas (regions of negative slope), making the tri-regime propellant useful in applications typically filled by plateau-burning double-base propellants, such as cartridge-actuated devices and propellant-actuated devices (CAD/PAD). The tri-regime propellant is anticipated to benefit many rocket motors or other device types in which a propellant exhibiting broad burning rate plateaus or mesas are desired.

The invention provides propellant compositions capable of producing the desired plateau effects without the need for refractory metal oxides or ultrafine AP. As a result, the inventive propellant provides the desired burning profile and is safer to process and manufacture as compared to the prior art.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

Thus, the breadth and scope of the subject matter provided in this Disclosure should not be limited by any of the above explicitly described embodiments. Rather, the scope of this Disclosure should be defined in accordance with the following claims and their equivalents.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which embodiments of the invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A composite propellant exhibiting at least three different combustion regimes each characterized by a distinct burning rate slope; the burning rate slopes of adjacent regimes not equaling each other.

2. The composite propellant of claim 1 wherein the first combustion regime has a first burning rate slope, the second regime has a second burning rate slope which is less than the first burning rate slope, and the third regime has a third burning rate slope greater than the second burning rate slope.

3. The composite propellant of claim 2, wherein the second burning rate slope is a negative slope.

4. The composite propellant of claim 1 wherein the propellant operates at a first pressure during the first regime, the propellant operates at a second pressure during the second regime, the second pressure being greater than the first pressure, and the propellant operates at a third pressure during the third regime, the third pressure being greater than the second pressure.

5. The composite propellant of claim 1 wherein a first burning rate in the first regime increases as a function of pressure, a second burning rate does not change as a function of pressure during the second regime, and a third burning rate in the third regime third regime increases as a function of pressure.

6. The composite propellant of claim 1, further comprising a polymer binder, surfactant and unaggregated, unagglomerated dispersed primary metal nanoparticles.

7. The composite propellant of claim 6, wherein the metal is aluminum.

8. The composite propellant of claim 6, wherein the surfactant is 1 to 10 wt % of the composite propellant.

9. The composite propellant of claim 6, wherein the surfactant is one or more of be a non-ionic, anionic, cationic or zwitterionic surfactant.

10. The composite propellant of claim 6, further comprising an oxidizing agent.

11. The composite propellant of claim 6, wherein the unaggregated, unagglomerated dispersed primary metal nanoparticles comprise 0.01-15 wt % of the solid composite propellant.
